(19) United States
(12) Patent Application Publication
(10) Pub. No.: US 2004/0123126 A1
(43) Pub. Date: Jun. 24, 2004

(54) Method and apparatus for deterring piracy

(76) Inventor: Whay S. Lee, Newark, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/328,527

(22) Filed: Dec. 24, 2002

(51) Int. Cl. H04L 9/00; G06F 17/60

(52) U.S. Cl. 713/193; 705/64

(57) ABSTRACT

Methods and apparatuses to deter piracy through localization with proprietary information. In one aspect of the invention, a method to deter piracy includes combining the proprietary data (e.g., financial information, such as a credit card or debit card number, a checking account number, or a purchase account number, or others such as social security number) of a customer with the content purchased by the customer to generate a customized version of the bought content for the customer so that the access to the customized bought content is bundled with the access to the proprietary data of the customer. In one example, the proprietary data is used to generate an encryption key to encrypt the bought content so that the proprietary data is required to decrypt the bought content; in another example, the proprietary data is used to generate a password (or registration key) to protect the access to the bought content; in a further example, the proprietary data is embedded in the customized bought content so that the a user of the bought content can also view the proprietary data.

### FIELD OF THE INVENTION

The invention relates to deterring piracy, and more particularly to deterring piracy for information distributed on machine readable media.

### BACKGROUND OF THE INVENTION

Piracy is a major problem faced by creators and manufacturers of digital content (e.g., music and movies, electronic books, software programs, and others). Because it is very easy to duplicate and distribute digital content, the seller risks creating a new source of pirated versions of the product every time a copy of the product is sold to a customer.

Currently used methods for deterring piracy include using dongles, copy protection schemes, encryption and decryption keys, registration keys or passwords, and taking legal actions against piracy. However, a dongle must be physically delivered to the user; and the dongle is cumbersome for the user. Copy protection schemes prevent users from making legitimate copies, such as back up copies; and rouge users often crack such copy protection schemes. Registration keys are frequently used for protecting shrink-wrapped software programs. However, customers may casually share the software programs with friends by providing the registration keys (passwords, or decryption keys) with the installation media to their friends. Overly general and sweeping legislation may garner negative sentiments from the customers. Legal actions are not effective in deterring individual customers from sharing bought contents with friends, since: a) the individual customers do not have much assets to pay for damages; b) it is bad public relations to bankrupt individual customers; and c) there are so many individual customers who casually share their bought contents with their friends that litigations against these individuals are difficult and not cost effective.

### SUMMARY OF THE DESCRIPTION

Methods and apparatuses to deterring piracy through localization with proprietary information are described here. At least one embodiment of the present invention is summarized in this section.

In one aspect of the invention, a method to prepare information for distribution includes: receiving proprietary data from a receiving party of the information; and integrating the information with at least a portion of the proprietary data to generate customized data. The customized data is for distribution to the receiving party; and, a copy of the portion of the proprietary data is required to authenticate the use of the information embedded in the customized data. In one example according to this aspect, the proprietary data comprises a financial account number (e.g., a credit card or debit card number) of the receiving party. It is determined whether or not the proprietary data belongs to the receiving party; and the customized data is for distribution to the receiving party if the proprietary data belongs to the receiving party. In one example, the copy of the proprietary data is at least a portion of a password required to authenticate the use of the information embedded in the customized data; in another example, the proprietary data is capable of being presented to a user of the customized data; and in a further example, the information is encrypted with an encryption key including at least a portion of the proprietary data to generate the customized data. In one example, the proprietary data is embedded in the information to generate the customized data.

In one aspect of the invention, a method of decryption includes: receiving first data; and decrypting customized data using a decryption key comprising at least a portion of the first data; where the customized data is encrypted with an encryption key comprising at least a portion of proprietary data (e.g., a financial account number, such as a credit card number or a debit card number) of a receiving party before the customized data is for distribution to the receiving party. In one example according to this aspect, the first data is received from a user of the customized data; in another example, the first data is received from a file which is for distribution with the customized data.

In one aspect of the invention, a method to display proprietary data includes: retrieving proprietary data from customized data; and displaying the proprietary data to a user of the information embedded in the customized data. The proprietary data (e.g., a financial account number, such as a credit card number) of a receiving party of the customized data is integrated with information purchased by the receiving party in the customized data before the customized data is distributed to the receiving party. In one example, the proprietary data is displayed in response to receiving a request from the user (e.g., through a user interface for using the customized data); in another example, the proprietary data is displayed in response to the information being retrieved from the customized data; in a further example, the customized data includes executable instructions, and the proprietary data is displayed in response to the execution of the instructions.

In one aspect of the invention, a method of authentication includes: receiving first data; and determining whether or not use of information embedded in customized data (e.g., retrieving the information from the customized data, executing computer instructions embedded in the customized data, or others) is authorized through the first data. The information being integrated with proprietary data (e.g., a financial account number, such as a credit card number or a debit card number) of a receiving party in the customized data before the customized data is distributed to the receiving party; and the use of the information is authorized if the first data matches at least a portion of the proprietary data. In one example according to this aspect, the first data is a portion of the customized data that contains a version of the proprietary data (e.g., an encrypted or hashed version); and the first data matches the proprietary data if it is determined that the portion of customized data is not altered. The portion of the customized data is readable without restriction to a user who has access to the customized data. In another example, the first data is received from a user of the customized data.

The present invention includes apparatuses which perform these methods, including data processing systems which perform these methods and computer readable media which when executed on data processing systems cause the systems to perform these methods.

Other features of the present invention will be apparent from the accompanying drawings and from the detailed description which follow.

### BRIEF DESCRIPTION OF THE DRAWINGS

The present invention is illustrated by way of example and not limitation in the figures of the accompanying drawings in which like references indicate similar elements.

FIG. 1 shows a block diagram example of a data processing system which may be used with the present invention.

FIG. 2 shows a diagram illustrating a method of combining the proprietary data of a customer with a digital content in order to deter piracy according to one embodiment of the present invention.

FIG. 3 shows a method to combine the proprietary data of a customer with a content to generate a customized content for delivery to the customer according to one embodiment of the present invention.

FIG. 4 shows a method to authenticate the use of the customized content using proprietary data of the customer according to one embodiment of the present invention.

FIG. 5 shows a method to decrypt the customized content using the proprietary data of the customer according to one embodiment of the present invention.

FIG. 6 shows a method to display the proprietary data of the customer embedded in the customized content according to one embodiment of the present invention.

### DETAILED DESCRIPTION

The following description and drawings are illustrative of the invention and are not to be construed as limiting the invention. Numerous specific details are described to provide a thorough understanding of the present invention. However, in certain instances, well known or conventional details are not described in order to avoid obscuring the description of the present invention.

Many of the methods of the present invention may be performed with a digital processing system, such as a conventional, general purpose computer system. Special purpose computers which are designed or programmed to perform only one function may also be used.

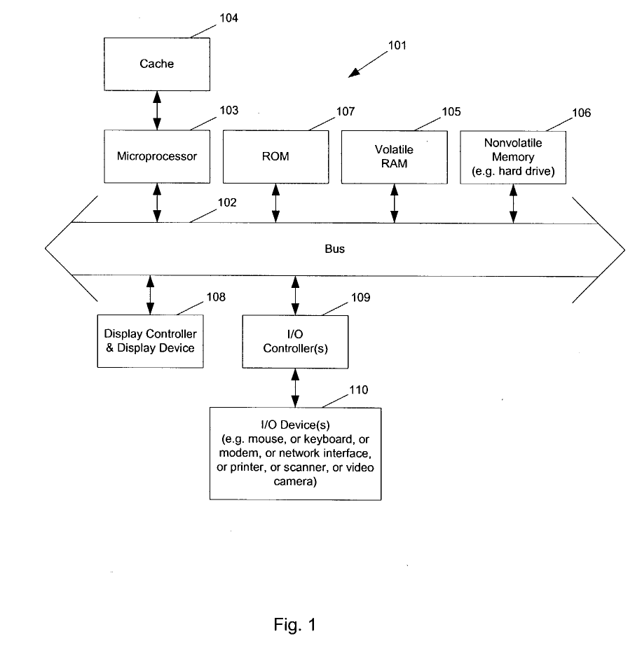

FIG. 1 shows one example of a typical computer system which may be used with the present invention. Note that while FIG. 1 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention. The computer system of FIG. 1 may, for example, be an Apple Macintosh computer.

As shown in FIG. 1, the computer system 101, which is a form of a data processing system, includes a bus 102 which is coupled to a microprocessor 103 and a ROM 107 and volatile RAM 105 and a non-volatile memory 106. The microprocessor 103, which may be a G3 or G4 microprocessor from Motorola, Inc. or IBM is coupled to cache memory 104 as shown in the example of FIG. 1. The bus 102 interconnects these various components together and also interconnects these components 103, 107, 105, and 106 to a display controller and display device 108 and to peripheral devices such as input/output (I/O) devices which may be mice, keyboards, modems, network interfaces, printers, scanners, video cameras and other devices which are well known in the art. Typically, the input/output devices 110 are coupled to the system through input/output controllers 109. The volatile RAM 105 is typically implemented as dynamic RAM (DRAM) which requires power continually in order to refresh or maintain the data in the memory. The non-volatile memory 106 is typically a magnetic hard drive or a magnetic optical drive or an optical drive or a DVD RAM or other type of memory systems which maintain data even after power is removed from the system. Typically, the non-volatile memory will also be a random access memory although this is not required. While FIG. 1 shows that the non-volatile memory is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 102 may include one or more buses connected to each other through various bridges, controllers and/or adapters as is well known in the art. In one embodiment the I/O controller 109 includes a USB (Universal Serial Bus) adapter for controlling USB peripherals, and/or an IEEE-1394 bus adapter for controlling IEEE-1394 peripherals.

It will be apparent from this description that aspects of the present invention may be embodied, at least in part, in software. That is, the techniques may be carried out in a computer system or other data processing system in response to its processor, such as a microprocessor, executing sequences of instructions contained in a memory, such as ROM 107, volatile RAM 105, non-volatile memory 106, cache 104 or a remote storage device. In various embodiments, hardwired circuitry may be used in combination with software instructions to implement the present invention. Thus, the techniques are not limited to any specific combination of hardware circuitry and software nor to any particular source for the instructions executed by the data processing system. In addition, throughout this description, various functions and operations are described as being performed by or caused by software code to simplify description. However, those skilled in the art will recognize what is meant by such expressions is that the functions result from execution of the code by a processor, such as the microprocessor 103.

A machine readable medium can be used to store software and data which when executed by a data processing system causes the system to perform various methods of the present invention. This executable software and data may be stored in various places including for example ROM 107, volatile RAM 105, non-volatile memory 106 and/or cache 104 as shown in FIG. 1. Portions of this software and/or data may be stored in any one of these storage devices.

Thus, a machine readable medium includes any mechanism that provides (i.e., stores and/or transmits) information in a form accessible by a machine (e.g., a computer, network device, personal digital assistant, manufacturing tool, any device with a set of one or more processors, etc.). For example, a machine readable medium includes recordable/non-recordable media (e.g., read only memory (ROM); random access memory (RAM); magnetic disk storage media; optical storage media; flash memory devices; etc.), as well as electrical, optical, acoustical or other forms of propagated signals (e.g., carrier waves, infrared signals, digital signals, etc.); etc.

The weakness of the currently used methods for deterring piracy stems from a fundamental difference between the content previously distributed on a machine readable media and physical merchandise: the customers have no interest or incentive to safe guard their bought content provided on the machine readable media, since a typical individual customer does not risk losing anything when the customer shares the bought content with others. The threat of litigation is effective in providing incentives to corporations against piracy practices; however, the threat of litigation is not effective for individual customers.

Integrating the bought content with the proprietary data of a customer can create a concrete and immediate incentive for the customer to safe guard the bought content. The integration may be done as part of a localization process in order to prepare the software for delivery to the recipient (e.g., customer). While the threat of litigation is an incentive for the customer to restraint from redistributing the bought content, it is more effective against piracy practices in corporations and less effective against individuals. When the propriety data of a customer (e.g., a credit card number, a debit card number, a bank account number, a purchase account number, social security number), which the customer has the incentive to safe guard, is combined with the bought content, customer has the incentive to safe guard the bought content. Thus, it is understood that the propriety data do not include information which a typical customer does not mind sharing with others, such as names of the customer.

Digital contents, especially that are distributed over the Internet, are usually bought with credit cards. A credit card number may be combined with the bought digital content to generate customized content for the customer before it is delivered to the customer such that the credit card number is required to use the content and/or the credit card number can be revealed to the user of the content. The customer must distribute the credit card number and/or risk divulging the credit card number to redistribute the bought content. Since the customer has a vested interest in preventing the distribution of the credit card number, the customer has the incentive to safe guard the bought content.

For example, the credit card number may be used as a registration key or encryption key, which is required for the proper installation of the content; or, the credit card number may be used as a password which must be presented to used the content. The password based on the credit card number may be presented in a file for authentication, which may be viewed by an user of the content. The credit card number may be displayed prominently whenever the content is installed or used on a machine. The credit card number may be made available for viewing whenever the content is being used. For example, a button with a label “click here to see sales receipt” can be used to display the credit card information to the user. Using such a button or other means to accept a request for viewing the sales receipt is more appropriate than simply displaying the credit card number, since a casual passerby should not be able to easily see the credit card number. The credit card number may be embedded in a location known to the public, which may be checked against tempering in order for the content to function properly. The credit card number can be encrypted with weak strength, which is strong enough to prevent an average customer from cracking it, but not strong enough against purposeful hackers. The credit card number may be protected with strong encryption; however, a user provided with access (e.g., the registration key or password) to the digital content has access to the credit card number embedded in the customized product (e.g., through a sales receipt button).

A customer may potentially cancel the credit card account after purchasing the content and then proceed to distribute pirated version of the content. However, a customer has a incentive to avoid repeated canceling credit card account due to the abnormal pattern which may appear in the credit history of the customer and due to the inconvenience in repeatedly applying for a new account.

The credit card account may expire, which may remove the deterrence. However, most digital contents have limited useful life spans (e.g., after a few years, a software program becomes obsolete, music becomes less popular, etc), in which deterring piracy involving individuals may result in huge benefits. Thus, the effect of deterrence is still significant in the life cycle of the product.

In one embodiment of the present invention, the credit card number is checked periodically to verify its validity. When the credit card number integrated with the customized product is not valid (expired or cancelled), the customer is required to supply a new valid credit card number (which is verified to be valid) to replace the expired one to keep the content functioning properly. Such an embodiment may be use with digital contents with a relatively long life span.

Some embodiments of the present invention deter the customers from sharing the bought contents with those whom the customers do not want to share their proprietary data with. These embodiment embodiments may not deter the customers from sharing the bought contents with those whom the customers do not mind to share their proprietary data with; and the customers are not prevented from using the bought content on multiple machines of their own. This may be a reasonable compromise, where the customers get unlimited personal use of the content while the seller gets a deterrent against wide spread piracy.

Further, the method of combining the proprietary data of the customer with bought contents may be combined with currently well known methods for piracy deterrence to achieve a desirable usage policy. For example, dongles may be used in combination with embodiments of the present invention to limit the simultaneous use of bought content; or registration keys that requires identification information of the hardware of the computer may be used to restrict the number of installations on different computers.

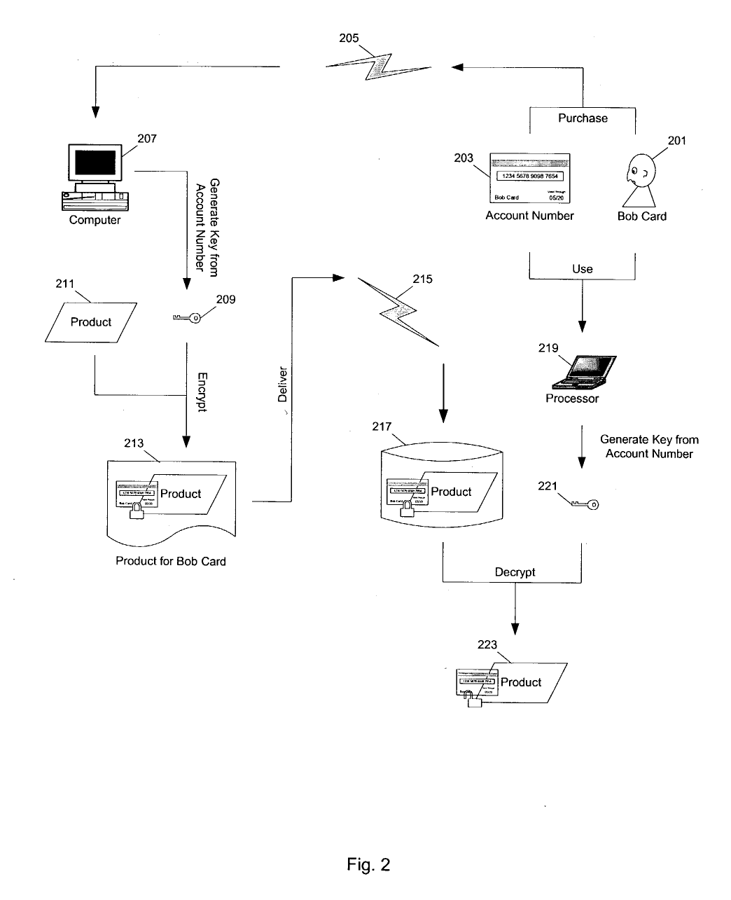

FIG. 2 shows a diagram illustrating a method of combining the proprietary data of a customer with a digital content for deterring piracy according to one embodiment of the present invention. When customer 201 purchases a copy of product 211, the customer 201 is required to present financial information 203 (e.g., a credit card or debit card number, a checking account number, or a purchase account number) or some other data which the customer would prefer to maintain in confidence (e.g., social security number) for the payment purpose. Such financial information, which are typically used in a purchase transaction, is ready to be verified. However, other proprietary data of the customer can also be used. Once the purchase order and the financial information 203 are transmitted to the seller through communication channel 205 (e.g., through Internet, or a telecommunication system, or through a mail delivery system), financial information 203 can be combined with product 211 by data processing system 207 to generate customized product 213 for customer 201. Alternatively, the seller may have the financial information of customer 201 in a database; and such information can be retrieved from the database when the identity of customer 201 is confirmed. In one embodiment of the present invention, financial information 203 is used to generate encryption key 209, which is used to encrypt product 211 to generate customized product 213. For example, the credit card number or a portion of the credit card number can be used as the encryption key or a portion of the encryption key; or an encryption key can be generated from hashing the financial information or a portion of the information. Alternatively, a password can be generated from the financial information to protect the encrypted customized product 213 (or, packaged using other means). In one embodiment of the present invention, financial information 203 is also embedded in the customized information so that when a user has access to the bought content in customized product 213, the user also has the access to the financial information embedded in customized product 213. Authentication means, such as a registration key, a decryption key or a password, which may or may not be generated from financial information 203, can be used to selectively provide access to customer 201. Customized product 213 is delivered to customer 201 on machine readable media 215 (e.g., a CD-ROM, a DVD-ROM, a network transmission media, a telecommunication media, or others). Once customized product 213 is transported to the customer, the customer may use the customized product 217 on data processing system 219 (e.g., a computer, a DVD player, a hand held PDA, and others). In one embodiment of the present invention, authentication means for the customized product, such as registration keys, decryption keys, or passwords, are generated at least partially from financial information 203. The user must present financial information 203 to generate key 221 to use the customized product (e.g., install the software program, run the software program, play the audio tracks, viewing the movie, and others). If the customer wants to share the customized product with others, the customer must share financial information 203 with them. In one embodiment of the present invention, the authentication key may or may not be generated from the financial information; however, once the user is authorized to use customized product 223, the user is allowed to view the financial information embedded in customized product 223. Thus, the access to a bought version of product 211 is bundled with the access to financial information 203; and the desire of the customer to safe guard financial information 203 keeps the customer from sharing the bought version of product 211, resulting in piracy deterrence.

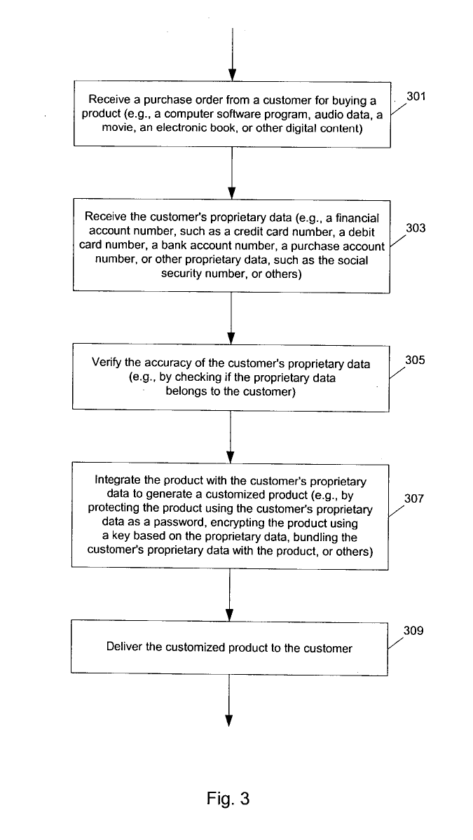

FIG. 3 shows a method to combine the proprietary data of a customer with a content to generate a customized content for delivery to the customer according to one embodiment of the present invention. After operation 301 receives a purchase order from a customer for buying a product (e.g., a computer software program, audio data, a movie, an electronic book, or other digital content which is readable by a machine and causes the machine to perform an operation), operation 303 receives the proprietary data of the customer (e.g., a financial account number, such as a credit card number, a debit card number, a bank account number, a purchase account number, or other proprietary data, such as the social security number, or others). The product on a machine readable media may not be in a digital format; and proprietary data may be received directly from the customer or from a database with the consent from the customer. Operation 305 verifies the accuracy of the customer's proprietary data (e.g., by checking if the proprietary data belongs to the customer). After operation 307 integrates the product with the customer's proprietary data to generate a customized product (e.g., by protecting the product using the customer's proprietary data as a password, encrypting the product using a key based on the proprietary data, bundling the customer's proprietary data with the product, or others), the customized product is delivered to the customer in operation 309. The customized product may be delivered through Internet, or through mail on a machine readable media, such as a CD-ROM or a DVD-ROM.

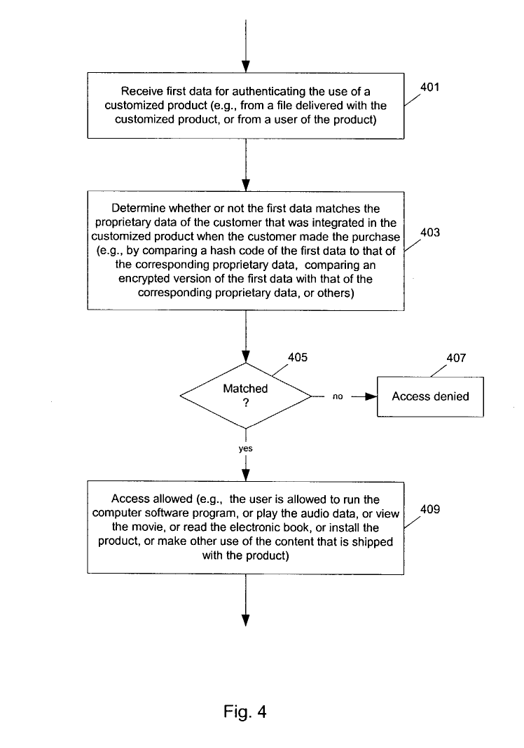

FIG. 4 shows a method to authenticate the use of the customized content using proprietary data of the customer according to one embodiment of the present invention. Operation 401 receives first data for authenticating the use of a customized product (e.g., from a file delivered with the customized product, or from a user of the product). Operation 403 determine whether or not the first data matches the proprietary data of the customer that was integrated in the customized product when the customer made the purchase (e.g., by comparing a hash code of the first data to that of the corresponding proprietary data, comparing an encrypted version of the first data with that of the corresponding proprietary data, or others). If operation 405 determines that the first data does not match the proprietary data, access to the bought content is denied in operation 407; otherwise, access to the bought content is allowed (e.g., the user is allowed to run the computer software program, or play the audio data, or view the movie, or read the electronic book, or install the product, or make other use of the content that is shipped with the product) in operation 409.

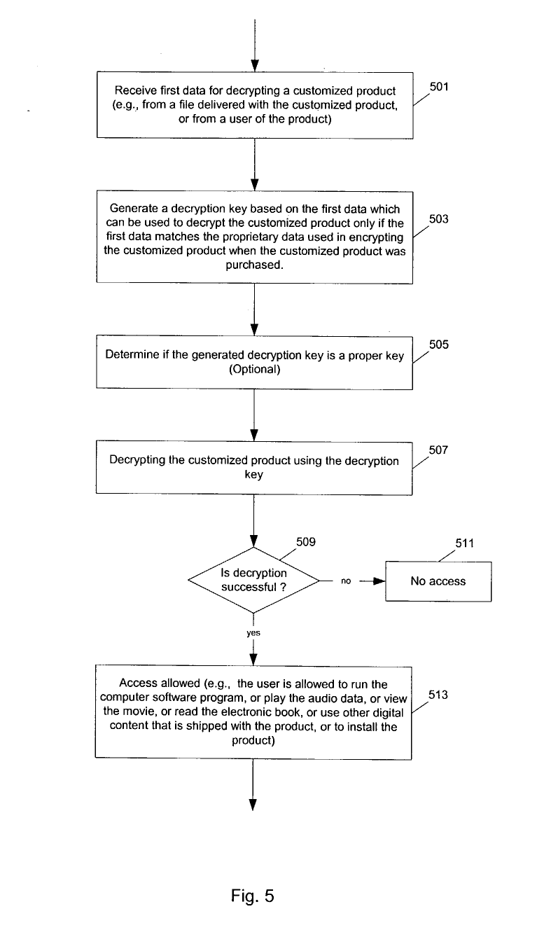

FIG. 5 shows a method to decrypt the customized content using the proprietary data of the customer according to one embodiment of the present invention. Operation 501 receives first data for decrypting a customized product (e.g., from a file delivered with the customized product, or from a user of the product). Operation 503 generates a decryption key based on the first data which can be used to decrypt the customized product if the first data matches the proprietary data used in encrypting the customized product when the customized product was purchased. Operation 505 optionally determines if the generated decryption key is a proper key; and decryption will fail without a proper key. Operation 507 decrypts the customized product using the decryption key. If operation 509 determines that the decryption is not successful, no access to the bought content is available (operation 511); otherwise, access to the bought content is allowed (e.g., the user is allowed to run the computer software program, or play the audio data, or view the movie, or read the electronic book, or use other digital content that is shipped with the product, or to install the product) in operation 513.

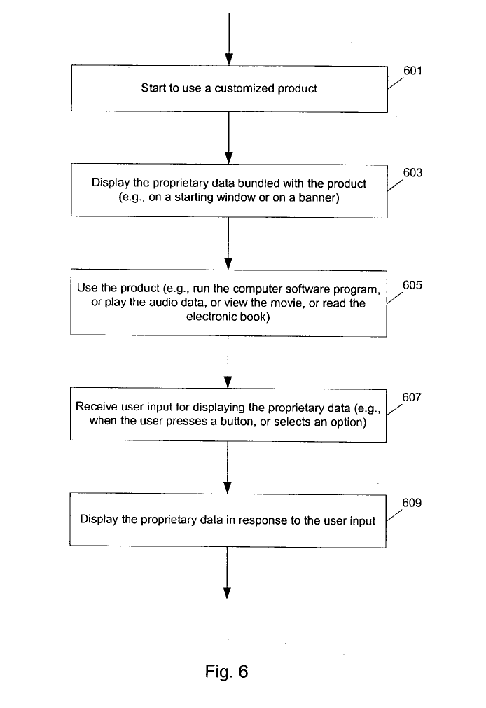

FIG. 6 shows a method to display the proprietary data of the customer embedded in the customized content according to one embodiment of the present invention. After operation 601 starts to use a customized product, operation 603 automatically displays the proprietary data bundled with the product (e.g., on a starting window or on a banner). A user may use the product (e.g., run the computer software program, or play the audio data, or view the movie, or read the electronic book) in operation 605. After operation 607 receives user input for displaying the proprietary data (e.g., when the user presses a button, or selects an option), operation 609 displays the proprietary data in response to the user input. In one embodiment of the present invention, operation 603 is not performed so that the proprietary information of the customer is not displayed to a passerby. In another embodiment of the present invention, operations 607 and 609 are not performed; and the proprietary data is automatically displayed when the bought content is used. In a further embodiment of the present invention, the proprietary data is normally not displayed; however, the proprietary data is bundled with the bought information and available for viewing if a user uses a commonly available tool or available only to purposeful hackers.

From this description, it is apparent to one skilled in the art that the methods of FIGS. 4-6, with each other and with other methods, may be combined in various ways to deter piracy.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method to prepare information for distribution, the method comprising:
receiving proprietary data from a receiving party of the information; and
integrating the information with at least a portion of the proprietary data to generate customized data;
wherein the customized data is for distribution to the receiving party; and, a copy of the portion of the proprietary data is required to authenticate use of the information embedded in the customized data.

2. A method as in claim 1 wherein the proprietary data comprises a financial account number of the receiving party.

3. A method as in claim 2 wherein the financial account number is one of:
a) a credit card number; and
b) a debit card number.

4. A method as in claim 2 further comprising:
determining whether or not the proprietary data belongs to the receiving party;
wherein the customized data is for distribution to the receiving party if the proprietary data belongs to the receiving party.

5. A method as in claim 2 wherein the copy of the portion of the proprietary data comprises at least a portion of a password to authenticate the use of the information embedded in the customized data.

6. A method as in claim 2 wherein the proprietary data is capable of being presented to a user of the customized data.

7. A method as in claim 2 wherein said integrating the information with the proprietary data comprises:
encrypting the information with an encryption key comprising at least a portion of the proprietary data to generate the customized data.

8. A method as in claim 2 wherein said integrating the information with the proprietary data comprises:
embedding the proprietary data in the information to generate the customized data.

9. A method of decryption, the method comprising:
receiving first data; and
decrypting customized data using a decryption key comprising at least a portion of the first data, the customized data being encrypted with an encryption key comprising at least a portion of proprietary data of a receiving party before the customized data is distributed to the receiving party.

10. A method as in claim 9 wherein the proprietary data comprises a financial account number of the receiving party.

11. A method as in claim 10 wherein the financial account number is one of:
a) a credit card number; and
b) a debit card number.

12. A method as in claim 11 wherein the first data is received from a user of the customized data.

13. A method as in claim 11 wherein the first data is received from a file which is for distribution with the customized data.

14. A method to display data, the method comprising:
retrieving proprietary data from customized data, the proprietary data of a receiving party being integrated with information in the customized data before the customized data is distributed to the receiving party; and
displaying the proprietary data to a user of the information embedded in the customized data.

15. A method as in claim 14 wherein the proprietary data comprises a financial account number of the receiving party.

16. A method as in claim 15 wherein the financial account number is one of:
a) a credit card number; and
b) a debit card number.

17. A method as in claim 15 further comprising:
receiving a request from the user to display the proprietary data;
wherein said displaying is in response to the request.

18. A method as in claim 15 wherein said displaying is in response to the information being retrieved from the customized data.

19. A method as in claim 15 wherein the customized data comprises executable instructions, and wherein said displaying is in response to execution of the instructions.

20. A method of authentication, the method comprising:
receiving first data; and
determining whether or not use of information embedded in customized data is authorized through the first data, the information being integrated with proprietary data of a receiving party in the customized data before the customized data is distributed to the receiving party;
wherein the use of the information is authorized if the first data matches at least a portion of the proprietary data.

21. A method as in claim 20 wherein the proprietary data comprises a financial account number of the receiving party.

22. A method as in claim 21 wherein the financial account number is one of:
a) a credit card number; and
b) a debit card number.

23. A method as in claim 21 wherein the first data is a portion of the customized data; said determining comprises:
determining whether or not the portion of the customized data is altered, the portion of the customized data comprising a version of the proprietary data;
wherein the first data matches the proprietary data if the portion of customized data is not altered.

24. A method as in claim 23 wherein the portion of the customized data is readable without restriction to a user who has access to the customized data.

25. A method as in claim 21 wherein the first data is received from a user of the customized data.

26. A method as in claim 25 wherein the use of the customized data comprises retrieving the information from the customized data.

27. A method as in claim 25 wherein the use of the customized data comprises executing computer instructions embedded in the customized data.

28. A computer readable medium containing customized data generated by executing computer program instructions which when executed on a first data processing system causes the first system to perform a method to prepare information for distribution on the medium, the method comprising:
receiving proprietary data from a receiving party of the information; and
integrating the information with at least a portion of the proprietary data to generate the customized data;
wherein the customized data is for distribution to the receiving party on the medium; and, a copy of the portion of the proprietary data is required to authenticate use of the information embedded in the customized data.

29. A medium as in claim 28 wherein the proprietary data comprises a financial account number of the receiving party.

30. A medium as in claim 29 wherein the financial account number is one of:
a) a credit card number; and
b) a debit card number.

31. A medium as in claim 29 wherein the method further comprises:
determining whether or not the proprietary data belongs to the receiving party;
wherein the customized data is for distribution to the receiving party if the proprietary data belongs to the receiving party.

32. A medium as in claim 29 wherein the copy of the portion of the proprietary data comprises at least a portion of a password to authenticate the use of the information embedded in the customized data.

33. A medium as in claim 32 wherein the medium further contains executable computer program instructions which when executed by a second digital processing system cause the second system to perform an authentication method comprising:
receiving first data; and
determining whether or not use of the information embedded in customized data is authorized;
wherein the use of the information is authorized if the first data matches at least a portion of the proprietary data.

34. A medium as in claim 29 wherein the proprietary data is capable of being presented to a user of the customized data.

35. A medium as in claim 34 wherein the medium further contains executable computer program instructions which when executed by a second digital processing system cause the second system to display the information to a user of the customized data.

36. A medium as in claim 29 wherein said integrating the information with the proprietary data comprises:
encrypting the information with an encryption key comprising at least a portion of the proprietary data to generate the customized data.

37. A medium as in claim 36 wherein the medium further contains executable computer program instructions which when executed by a second digital processing system cause the second system to perform a decryption method comprising:
receiving first data; and
decrypting the customized data using a decryption key comprising at least a portion of the first data.
